(19) United States
(12) Patent Application Publication
(10) Pub. No.: US 2019/0195455 A1
(43) Pub. Date: Jun. 27, 2019

(54) HEADLIGHT DEVICE

(71) Applicant: INDUSTRIAL TECHNOLOGY RESEARCH INSTITUTE, Hsinchu (TW)

(72) Inventors: Luan-Ying CHEN, Changhua County (TW); Kao Der Chang, Taichung City (TW)

(73) Assignee: INDUSTRIAL TECHNOLOGY RESEARCH INSTITUTE, Hsinchu (TW)

(21) Appl. No.: 15/853,470

(22) Filed: Dec. 22, 2017

(30) Foreign Application Priority Data
Dec. 22, 2017 (TW) 106145185

(51) Int. Cl. F21S 41/32; F21S 41/255; F21S 41/43; F21S 41/147

(52) U.S. Cl. CPC F21S 41/32; F21S 41/147; F21S 41/43; F21S 41/255

(57) ABSTRACT

A headlight device includes a light source, a reflection mirror, a Fresnel lens and a blocking plate. The light source and the reflection mirror are disposed on a circuit board. After the light beam emitted from the light source is reflected by the reflection mirror, the light beam is gathered and projected to the Fresnel lens. By the means of the refraction through the Fresnel lens, a light shape which is applied to a vehicle is produced. The blocking plate is configured to produce a light shape with cut-off line.

### TECHNICAL FIELD

The disclosure relates to a headlight device.

### BACKGROUND

Vehicle all have headlight device to illuminate the front for drives. The conventional headlight device uses a bulb as light source, and the bulb is surrounded and covered by a semi-ellipsoid reflecting mirror and cooperates with a symmetrical lens, such that light emitted by the bulb is able to be projected to the front of the vehicle. In order to prevent a sight from being disturbed by the light from another vehicle coming in the opposite direction, there is a regulation about a light pattern of the headlight device to ensure the illuminating range of the headlight device is sufficient, and also about a clear cut-off line of the light pattern for preventing mutual disturbing from vehicles coming from opposite directions.

The conventional headlight device only can project light to the front of the vehicle, if the vehicle is moving on a winding mountain road, the drive is not able to recognize the road behind corner. Therefore, an adaptive front lighting system is developed for adjusting the light projecting direction of the headlight device as the steering wheel turns. However, the semi-ellipsoid reflecting mirror and the symmetric lens are larger and heavy, it will cause the headlight device insensitive in turning, making the conventional headlight device unable to immediately turn to the desired direction, such that the driver is unable to recognize the road behind the corner, and such headlight device is also hard to meet the regulation.

### SUMMARY

The disclosure provides a headlight device, which is thin and lightweight and is capable of solving the aforementioned problems that the headlight cooperated with the adaptive front lighting system is not sensitive in turning the projecting direction.

One embodiment of the disclosure provides a headlight device which includes a light source, a reflector, a Fresnel lens and a blocking plate. The light source is disposed on a circuit board, and has a light emitting surface. The reflector is disposed on a side of the circuit board and covers the light source. The reflector has a reflecting surface facing the light emitting surface, and an opening is formed by a side of the reflecting surface. An angle formed by a direction of the opening and the normal line of the light emitting surface is equal to or greater than 90 degrees. The Fresnel lens is located on a side of the opening opposite to the light source. A light beam emitted from the light emitting surface is reflected by the reflecting surface and then passes through the Fresnel lens. The light beam converges towards an energy convergence area on a vertical plane, and the blocking plate is located between the vertical plane and the light source in order to block part of the light beam so as to create a light pattern having a cut-off. A reference plane is defined to perpendicular to the opening, and an optical axis of the light source is on the reference plane. The reflecting surface and the reference plane intersect at a curved line on the reflecting surface, and the curved line has an opening end and a connecting end opposite to each other. The connecting end is located on a side of the reflector close to the circuit board. The curved line is defined by a quadratic Bezier curved function, and the quadratic Bezier curved function comprises:

Bₓ(t)=(1−t)²P₀ₓ+2t(1−t)P₁ₓ+t²P₂ₓ, t∈[0,1]; and

B_{y}(t)=(1−t)²P_{0y}+2t(1−t)P_{1y}+t²P_{2y}, t∈[0,1];

wherein the connecting end is an origin of a coordinate, the X-coordinate and the Y-coordinate of the connecting end are respectively P₀ₓ and P_{0y}, the X-coordinate and the Y-coordinate of the opening end are respectively P₂ₓ and P_{2y}, the X-coordinate and the Y-coordinate of a reference point in adjusting the curvature of the curved line are respectively P₁ₓ and P_{1y}, the coefficient in determining any point on the curved line is t, and the X-coordinate and the Y-coordinate of any point on the curved line are respectively Bₓ(t) and B_{y}(t).

According to the headlight device as discussed above, with the cooperation of the reflecting surface of the reflector, which is defined by the quadratic Bezier curved function, and the blocking plate, the light pattern produced by the light beam, emitted by the light source and then passing through the Fresnel lens, not only can meet the requirement of the regulation, but also can decrease the volume and the weight of the headlight device, thereby increasing the turning sensitivity of the headlight device cooperated with the adaptive front lighting system.

In addition, the Fresnel lens is smaller and lighter than the lens in the conventional headlight device, which also helps to increase the turning sensitivity of the headlight device cooperated with the adaptive front lighting system.

The aforementioned summary and the following detailed description are set forth in order to provide a thorough understanding of the disclosed embodiment and provide a further explanations of claims of the disclosure

### BRIEF DESCRIPTION OF THE DRAWINGS

FIG. 1 is a perspective view of a headlight device according to a first embodiment of the disclosure.

FIG. 2 is a cross-sectional view of FIG. 1.

FIG. 3 is a contour diagram of illuminance produced by the headlight device in FIG. 1.

FIG. 4 is a cross-sectional view of a headlight device according to a second embodiment of the disclosure.

FIG. 5 is a contour diagram of illuminance produced by the headlight device in FIG. 4.

FIG. 6 is a cross-sectional view of a headlight device according to a third embodiment of the disclosure.

FIG. 7 is a contour diagram of illuminance produced by the headlight device in FIG. 6.

FIG. 8 is a cross-sectional view of a headlight device according to a fourth embodiment of the disclosure.

FIG. 9 is a contour diagram of illuminance produced by the headlight device in FIG. 8.

FIG. 10 is a cross-sectional view of a headlight device according to a fifth embodiment of the disclosure.

FIG. 11 is a contour diagram of illuminance produced by the headlight device in FIG. 10.

FIG. 12 is a cross-sectional view of a headlight device according to a sixth embodiment of the disclosure.

FIG. 13 is a contour diagram of illuminance produced by the headlight device in FIG. 12.

FIG. 14 is a cross-sectional view of a headlight device according to a seventh embodiment of the disclosure.

FIG. 15 a contour diagram of illuminance produced by the headlight device in FIG. 14.

FIG. 16 is a front view of a Fresnel lens according to an eighth embodiment of the disclosure.

FIG. 17 is a front view of a Fresnel lens according to a ninth embodiment of the disclosure.

FIG. 18 is a front view of a Fresnel lens according to a tenth embodiment of the disclosure.

### DETAILED DESCRIPTION

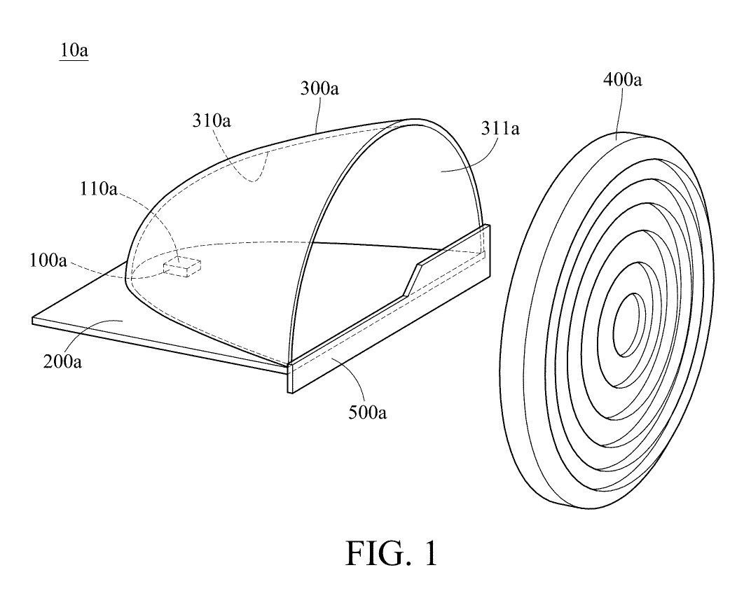

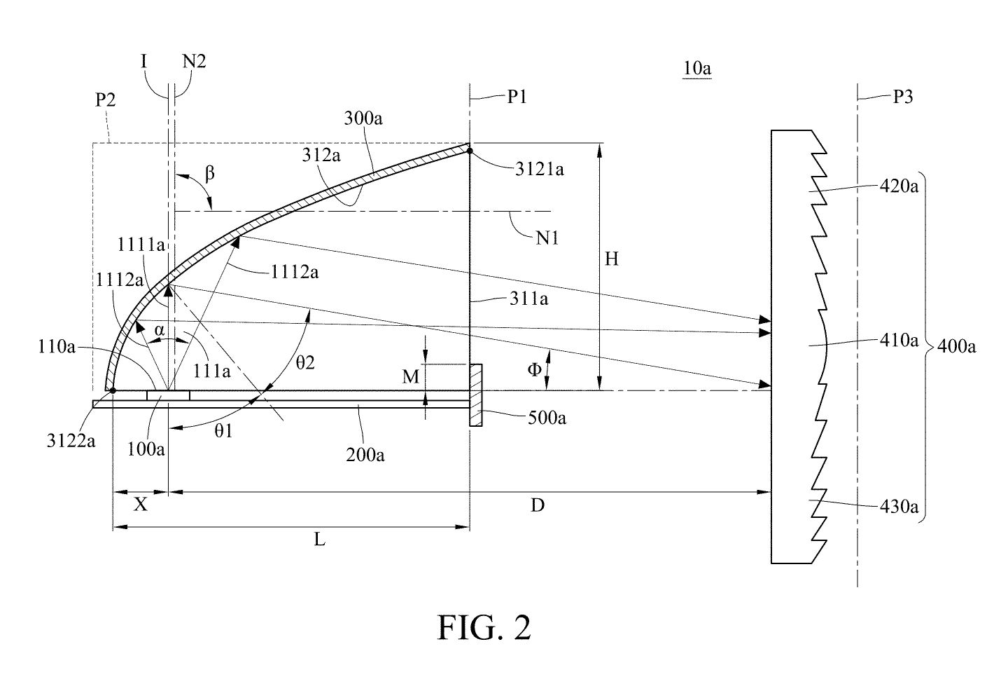

Please refer to FIG. 1 and FIG. 2. FIG. 1 is a perspective view of a headlight device according to a first embodiment of the disclosure. FIG. 2 is a cross-sectional view of FIG. 1.

The headlight device 10a of this embodiment is able to be cooperated with an adaptive front lighting system. The headlight device includes a light source 100a, a circuit board 200a, a reflector 300a, a Fresnel lens 400a and a blocking plate 500a. The light source 100a and the reflector 300a are disposed on the circuit board 200a. After a light beam 111a emitted by the light source 100a is reflected and converged by the reflector 300a, it will enter into the Fresnel lens 400a to be refracted and exist to form a collimating light beam adapting for vehicle lighting. The blocking plate 500a blocks part of the light beam 111a to create a light pattern having a cut-off line.

The light source 100a of this embodiment is, for example, a Lambertian source. In this embodiment, the light source 100a has, for example, a plurality of LEDs in an array arrangement and a guiding cover, and the guiding cover is located on an illuminating side of the LEDs in order to soften the light emitted by the LEDs and prevent the light from producing a moire fringe pattern. The light source 100a has a light emitting surface 110a, and the light beam 111a emitted from the light emitting surface 110a of the light source 100a has an optical axial light ray 1111a and edge light rays 1112a. The optical axial light ray 1111a overlaps an optical axis I of the light source 100a, and the light energy of the optical axial light ray 1111a is greater than the light energy of the edge light rays 1112a. The light beam 111a emitting from the emitting surface 110a has a divergence angle α equal to 90 degrees for instance. The divergence angle α is defined by the two edge light rays 1112a which are respectively located on two opposite sides of the optical axial light ray 1111a. In this embodiment, the divergence angle α of the light beam 111a emitted from the light emitting surface 110a is equal to 90 degrees, but the present disclosure is not limited thereto. In some other embodiments, the divergence angle α of the light beam 111a emitted from the light emitting surface 110a may range between 90 degrees and 120 degrees.

In the headlight device 10a of this embodiment, the reflector 300a is a half covering-type mirror. The reflector 300a is disposed on a side of the circuit board 200a, and covers the light source 100a. The reflector 300a has a reflecting surface 310a facing the light emitting surface 110a of the light source 100a. A side of the reflecting surface 310a surrounds and forms an opening 311a, a direction of the opening 311a and a normal line N2 of the light emitting surface 110a have an angle β; the angle β is an angle between a normal line N1 of a plane P1, where the opening 311a is located, and the normal line N2 of the light emitting surface 110a, and the angle β is equal to or greater than 90 degrees. In this embodiment, the angle β is 90 degrees. In addition, the plane P1, where the opening 311a is located, is aligned with an edge of the circuit board 200a, but the present disclosure is not limited thereto. In some other embodiments, a circuit board may indent from a plane, where the opening is located, or may stick out from the plane where the opening is located.

Then, a reference plane P2 is defined. The reference plane P2 is perpendicular to the plane P1, where the opening 311a is located, and the optical axis I of the light source 100a is located on the reference plane P2. In detail, FIG. 2 is a cross-section view of the headlight device 10a taken on the reference plane P2. The reflecting surface 310a and the reference plane P2 intersect at a curved line 312a on the reflecting surface 310a, and the curved line 312a has an opening end 3121a and a connecting end 3122a. The opening end 3121a is located on the plane P1, where the opening 311a is located, and the connecting end 3122a is located on a side of the reflector 300a close to the circuit board 200a. The curved line 312a is defined by a quadratic Bezier curved function, and the function includes:

Bₓ(t)=(1−t)²P₀ₓ+2t(1−t)P₁ₓ+t²P₂ₓ, t∈[0,1]; and

B_{y}(t)=(1−t)²P_{0y}+2t(1−t)P_{1y}+t²P_{2y}, t∈[0,1].

The connecting end 3122a is an origin of a coordinate, and the X-coordinate and the Y-coordinate of the connecting end 3122a are respectively P₀ₓ and P_{0y}. The X-coordinate and the Y-coordinate of the opening end 3121a are respectively P₂ₓ and P_{2y}. The X-coordinate and the Y-coordinate of a reference point in adjusting the curvature of the curved line 312a are respectively P₁ₓ and P_{1y}. The coefficient in determining any point on the curved line 312a is t. The X-coordinate and the Y-coordinate of any point on the curved line 312a are respectively Bₓ(t) and B_{y}(t).

The Fresnel lens 400a is located on another side of the opening 311a which is opposite to the light source 100a. The Fresnel lens 400a includes a central part 410a, an upper part 420a and a lower part 430a. The central part 410a is located between the upper part 420a and the lower part 430a, and the upper part 420a is closer to the opening end 3121a of the curved line 312a than the lower part 430a. In this embodiment, the light beam 111a is reflected by the reflecting surface 310a and then converges towards an energy convergence area. The so-called energy convergence area is where the smallest cross section of the light beam 111a being reflected by the reflector 300a. In addition, in this embodiment, a vertical plane P3, where the energy convergence area is located, is located on a side of the Fresnel lens 400a away from the light source 100a; that is, behind the Fresnel lens 400a. Therefore, the optical axial light ray 1111a being reflected by the reflecting surface 310a of the reflector 300a will enter into the upper part of the Fresnel lens 400a.

Then, a relationship between a position on the Fresnel lens 400a, where the optical axial light ray 1111a passes through, and a position of the vertical plane P3, where the energy convergence area is located, is illustrated from a position of the light source 100a and the shape of the curved line 312a. By adjusting the position of the light source 100a (i.e. adjusting a distance between the light source 100a and the connecting end 3122a of the reflector 300a), the optical axial light ray 1111a, after being reflected by the reflecting surface 310a of the reflector 300a, is ensured to be converged downwards and then to enter into the Fresnel lens 400a. Basically, the following condition is required: |B_{y}(tₓ)/tan(Φ)|≥L−X, wherein tₓ is a coefficient in determining a point on the curved line 312a which is corresponding to the light source 100a, angle Φ is an angle between the optical axial light ray 1111a of the light source 100a after being reflected by the reflecting surface 310a and the direction (i.e. the normal line N1) of the opening 311a, L is a horizontal distance between the opening end 3121a and the connecting end 3122a, and X is a distance between the light source 100a and the connecting end 3122a of the reflector 300a.

More specifically, when the condition that the optical axial light ray 1111a, after being reflected by the reflecting surface 310a and leaving from the reflector 300a, converges downwards is satisfied, the vertical plane P3, where the energy convergence area is located, is converged and located on the side of the Fresnel lens 400a away from the light source 100a. The following condition is required: |B_{y}(tₓ)/tan(Φ)|≥D, wherein D is a distance between the light source 100a and the Fresnel lens 400a. At this moment, the optical axial light ray 1111a, after being reflected by the reflecting surface 310a, will enter into the upper part 420a of the Fresnel lens 400a.

The aforementioned paragraphs describe the condition that the optical axial light ray 1111a enters into the upper part of the Fresnel lens 400a after being reflected by the reflector 300a, but the present disclosure is not limited thereto. In some other embodiments, a position of the light source or a shape of the curved line may be adjusted to change the vertical plane P3 to a side of the Fresnel lens 400a close to the light source 100a; that is between the Fresnel lens 400a and the light source 100a. By doing so, after the optical axial light ray 1111a being reflected, it will be changed to enter into the lower part 430a. In detail, if it is attempted to make the optical axial light ray 1111a to enter into the lower part 430a of the Fresnel lens 400a after being reflected by the reflecting surface 310a, the vertical plane P3, where the energy convergence area is located, would be located between the Fresnel lens 400a and the light source 100a, and then the position of the light source 100a is able to be adjusted in order to satisfy the following condition: |B_{y}(tₓ)/tan(Φ)|≤D.

Therefore, no matter the optical axial light ray 1111a enters into the upper part 420a or the lower part 430a, the part of the Fresnel lens 400a, where the optical axial light ray 1111a does not pass through, is able to be cut off. For example, when the optical axial light ray 1111a enters into the upper part 420a, the part of the lower part 430a is able to be cut off. On the contrary, the part of the upper part 420a would be cut off. By doing so, the volume and weight of the Fresnel lens 400a are further decreased.

The blocking plate 500a is disposed between the vertical plane P3, where the energy convergence area is located at, and the light source 100a. More specifically, the blocking plate 500a is located between the Fresnel lens 400a and the light source 100a, and the blocking plate 500a leans on the edge of the circuit board 200a. To ensure that the optical axial light ray 1111a would not be blocked by the blocking plate 500a after being reflected by the reflector 300a and to make the blocking plate 500a effectively block the others to form a light patter having a cut-off line, it requires to meet the following condition: M≤B_{y}(tₓ), wherein M is a vertical distance between the highest point of the blocking plate 500a and the connecting end 3122a.

In this embodiment, the blocking plate 500a leans on the circuit board 200a, but the present disclosure is not limited thereto. In some other embodiments, the blocking plate 500a may not lean on the edge of the circuit board 200a, and the blocking plate 500a and the circuit board 200a may be spaced apart by a distance, and the distance between the blocking plate 500a and the Fresnel lens 400a requires to be smaller than or equal to the focal length of the Fresnel lens 400a; that is, the blocking plate 500a is located between the focus of the Fresnel lens 400a and the Fresnel lens 400a or is located on the focus of the Fresnel lens 400a. In addition, if the blocking plate 500a and the circuit board 200a are spaced apart by a distance, the overall length of the blocking plate 500a is required to be large enough to block the opening 311a of the reflector 300a to prevent the scattered light from entering into the Fresnel lens 400a.

Among them, the optical axial light ray 1111a when being reflected by the reflecting surface 310 of the reflector 300a has an incident angle θ1 and a reflected angle θ2. To ensure that the optical axial light ray 1111a would converge and form the energy convergence area with other edge light rays 1112a after being reflected by the reflecting surface 310a, the incident angle θ1 and the reflected angle θ2 both are required to be smaller than 45 degrees while designing the curved line 312a.

To achieve that the incident angle θ1 and the reflected angle θ2 of the optical axial light ray 1111a are smaller than 45 degrees, the coefficient tₓ in determining a point on the curved line 312a which is corresponding to the light source 100a is required to be greater than 0.35, so that the X-coordinate of the light source 100a is required to meet the following condition: Bₓ(tₓ)=(1−tₓ)²P₀ₓ+2tₓ(1−tₓ)P₁ₓ+tₓ²P₂ₓ, tₓ∈(0.35,1], wherein the Bₓ(tₓ) is the X-coordinate of the light source 100a. Thus, the minimum value of the X-coordinate of the light source 100a is obtained.

In order to ensure that the light beam 111a emitted by the light source 100a can be reflected by the reflector 300a, the maximum value of the X-coordinate of the light source 100a is required to meet the following condition: L−H≥X, wherein H is a vertical distance between the opening end 3121a and the connecting end 3122a.

Therefore, the minimum value and the maximum value of the X-coordinate of the light source 100a are obtained by deriving the aforementioned conditions, i.e. (0.65²P₀ₓ+0.7 (1−0.35)P₁ₓ+0.35²P₂ₓ)<Bₓ(tₓ)<L−H.

In order to ensure that the light beam 111a after being reflected and then passing through the Fresnel lens 400a would not overly diverge and still meet the regulation of the light pattern, the minimum angle is defined by the optical axial light ray 1111a, after being reflected by the reflecting surface 310a, and the direction of the opening 311a and is required to be −28.78 degrees, and a luminous intensity direction passing through the Fresnel lens 400a and the direction of the opening 311a are required to have an angle ranging between 0 degree and −2 degrees, wherein negative value of the angles represents the angles below the direction of the opening 311a. The so-called luminous intensity direction is a path of a light ray in the light beam 111a which has the greatest luminous intensity and passes through the Fresnel lens 400a.

In other words, no matter how much the coefficient of the curved line 312a of the reflector 300a is, the angle between the optical axial light ray 1111a, after being reflected by the reflecting surface 310a, and the direction of the opening 311a must be greater than −28.78 degrees. In addition, except the limitation of the angle between the optical axial light ray 1111a, after being reflected by the reflecting surface 310a, and the direction of the opening 311a, the angle between the luminous intensity direction and the direction of the opening 311a can be ranging between 0 degree and −2 degrees by, for example, adjusting the curvature of the Fresnel lens 400a, or vertically moving upward the Fresnel lens 400a to utilize the stronger refractive power of the downside of the Fresnel lens 400a.

The following is a practical example, wherein the X-coordinate and the Y-coordinate of the connecting end 3122a of the curved line 312a on the reflector 300a at the reference plane P2 are respectively 0 and 0, the X-coordinate and the Y-coordinate of the connecting end 3122a of the curved line 312a are respectively 45 and 29.5, and the X-coordinate and the Y-coordinate of the reference point are respectively 0 and 17.728.

According to the aforementioned arrangement, the distance between the connecting end 3122a of the curved line 312a and the plane P1, where the opening 311a is located, is 45 mm (i.e. the horizontal distance L between the opening end 3121a and the connecting end 3122a), and the vertical distance H between the opening end 3121a and the connecting end 3122a is 29.5 mm. As such, the maximum value of the X-coordinate of the light source 100a is L-H=15.5 mm. In addition, under the condition that the incident angle θ1 and reflected angle θ2 of the optical axial light ray 1111a both are required to be smaller than 45 degrees, the minimum value of the X-coordinate of the light source 100a is 5.5. Therefore, the light source 100a is able to be disposed at a position that distances between 5.5 mm and 15.5 mm from the connecting end 3122a, i.e. the distance between the light source 100a and the connecting end 3122a of the reflector 300a ranges from 5.5 mm to 15.5 mm.

Then, in an example, the distance X between the light source 100a and the connecting end 3122a of the curved line 312a is 7 mm, the distance D between the light source 100a and the Fresnel lens 400a is 76 mm, and the front focal length, the diameter and the thickness of the Fresnel lens 400a are respectively 44.598 mm, 55 mm and 7 mm.

According to the aforementioned arrangement, when the angle between the normal line N1 of the plane P1, where the opening 311a is located, and the normal line N2 of the light emitting surface 110a is 90 degrees, and the divergence angle α of the light source 100a is equal to 90 degrees, then obtain: tₓ=0.395, B_{y}(tₓ)=13.23, and tan(Φ)=0.095.

As such, B_{y}(tₓ)/tan(Φ)=139.3 and D=76, and that satisfy the condition of |B_{y}(tₓ)/tan(Φ)|≥D. That is, the optical axial light ray 1111a enters into the upper part 420a of the Fresnel lens 400a after being reflected by the reflector 300a, and the vertical plane P3, where the energy convergence area is located, is located on the side of the Fresnel lens 400a away from the light source 100a.

In addition, B_{y}(tₓ)/tan(Φ)=139.3 and L−X=38 satisfy the condition of B_{y}(tₓ)/tan(Φ)>L−X. That is, the optical axial light ray 1111a, after being reflected by the reflector 300a, would converge downward to enter into the Fresnel lens 400a.

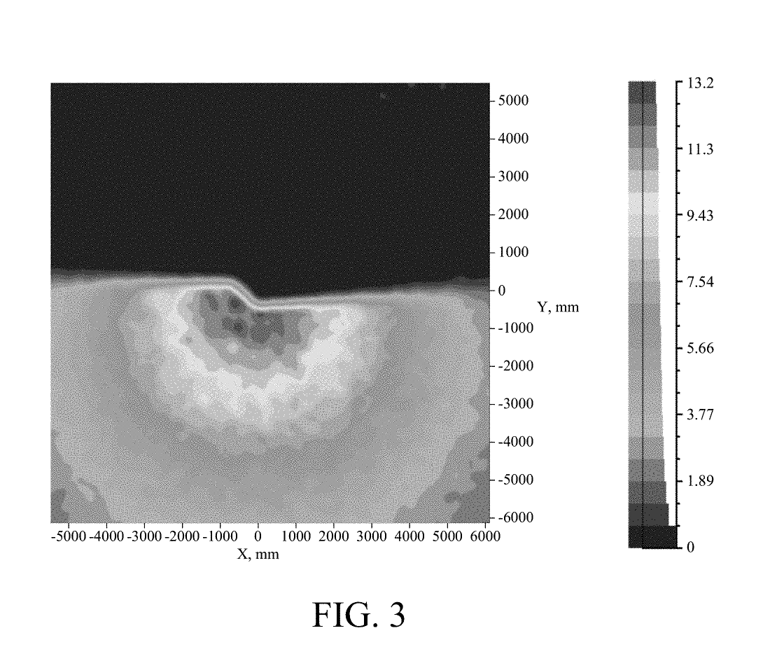

Please refer to FIG. 3. FIG. 3 is a contour diagram of illuminance produced by the headlight device in FIG. 1. In the aforementioned examples, it can be seen that the light beam 111a, passing through the Fresnel lens 400a and then projecting on a wall at 25 m away, creates a clear cut-off line, and the greater illuminance area is concentrated on the central area of the wall. That is, the reflecting surface 310a of the reflector 300a, which is defined by the quadratic Bezier curved function, with the help of the blocking plate 500a can make the light pattern, produced by the light beam emitted by the light source 100a and then passing through the Fresnel lens 400a, meets the requirement of the regulation.

In addition, in this embodiment, the position of the light source 100a can be adjusted by adjusting the distance X between the light source 100a and the connecting end 3122a of the reflector 300a, such that the optical axial light ray 1111a, after being reflected by the reflector 300a, is able to be adjusted to enter into the upper part 420a or the lower part 430a of the Fresnel lens 400a, and the part of the Fresnel lens 400a which is not passed by the optical axial light ray 1111a is able to be cut off, thereby further decreasing the volume and weight of the Fresnel lens 400a. As such, the Fresnel lens 400a is lightweight, and it helps to decrease the volume and weight of the overall headlight device 10a, such that the turning sensitivity of the headlight device 10a cooperated with the adaptive front lighting system is able to be increased.

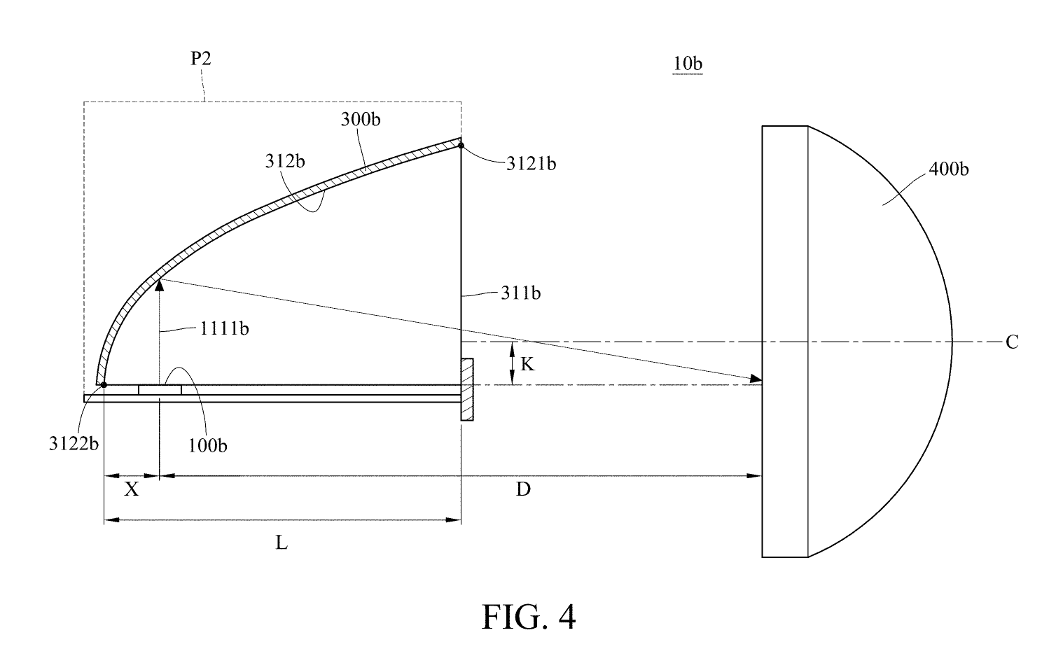

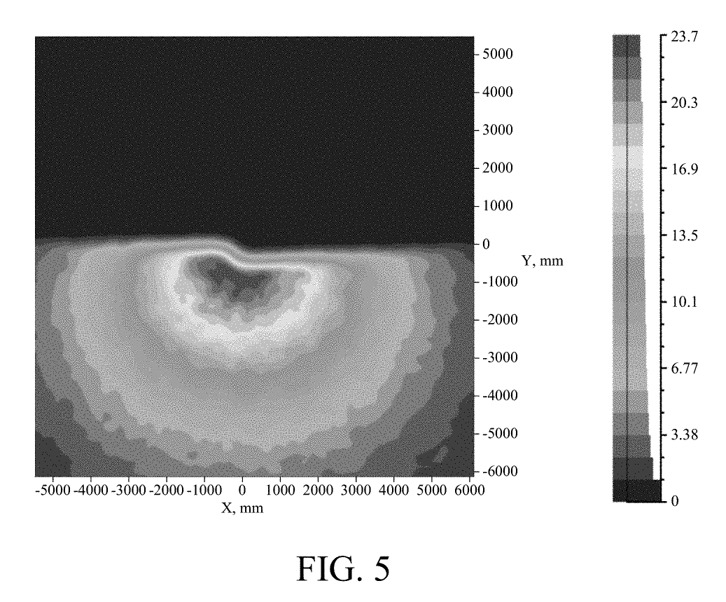

The aforementioned embodiment adopts the Fresnel lens, but the present disclosure is not limited thereto. Please refer to FIG. 4 and FIG. 5. FIG. 4 is a cross-sectional view of a headlight device according to a second embodiment of the disclosure. FIG. 5 is a contour diagram of illuminance produced by the headlight device in FIG. 4.

In a headlight device 10b of this embodiment, it adopts a hemisphere-type lens 400b, and the front focal length, the back focal length, the diameter and the thickness of the lens 400b are respectively 44.598 mm, 60.533 mm, 55 mm and 23.8 mm. The X-coordinate and the Y-coordinate of a connecting end 3122b of a curved line 312b of a reflector 300b on a reference plane P2 are respectively 0 and 0, the X-coordinate and the Y-coordinate of an opening end 3121b of the curved line 312b are respectively 45 and 29.5, the X-coordinate and the Y-coordinate of a reference point of the curved line 312b are respectively 0 and 17.728. A distance X between the connecting end 3122b of the curved line 312b and a light source 100b is 7 mm, a horizontal distance L between the connecting end 3122b of the curved line 312b and the opening end 3121b is 45 mm. The distance D between the light source 100b and the lens 400b is 76 mm.

The headlight device 10b in this embodiment is similar to the aforementioned headlight device 10a, and they are only different in appearance (the Fresnel lens 400a and the lens 400b). Therefore, a path of an optical axial light ray 1111b emitted by the light source 100b before entering into the lens 400b would be the same as that of the aforementioned embodiment because the reflectors 300b are the same in shape, so it is not repeated hereinafter.

However, the lens 400b of this embodiment is the optically equivalent lens of the aforementioned Fresnel lens 400a. Therefore, the Fresnel lens 400a and the lens 400b have similar characteristics, for example, they have similar capability of refracting and converging light. The Fresnel lens 400a and the lens 400b have one difference is that the thickness of the lens 400b would make a light ray enter into different position of the curved surface of the lens 400b resulting in different refractive power. Therefore, the strength of the refractive power is able to be adjusted by vertically moving the lens 400b.

In detail, by moving the lens 400b upward, a central axis C, passing through the lens 400b, and the connecting end 3122b have a vertical distance K therebetween, and the distance K is, for example, 5.5 mm. In other words, the central axis C of the lens 400b is moved 5.5 mm upward from the connecting end 3122b, and an illuminance contour diagram produced by the lens 400b is shown in FIG. 5.

According to the aforementioned arrangement, it can be seen that a clear cut-off line on a wall at 25m away is produced by the headlight device 10b, and the greater illuminance area is concentrated on the central area of the wall. As such, a light pattern produced by the headlight device 10b meets the requirement of the regulation.

To further compare with FIG. 2 and FIG. 4, although the lens 400b in the embodiment of FIG. 4 is the equivalent lens of Fresnel lens 400a in the embodiment of FIG. 2 and is able to produce similar effect, the volume of the headlight device 10a having symmetrically disposed and flat Fresnel lens 400a is 33.05% of the volume of the headlight device 10b having the lens 400b.

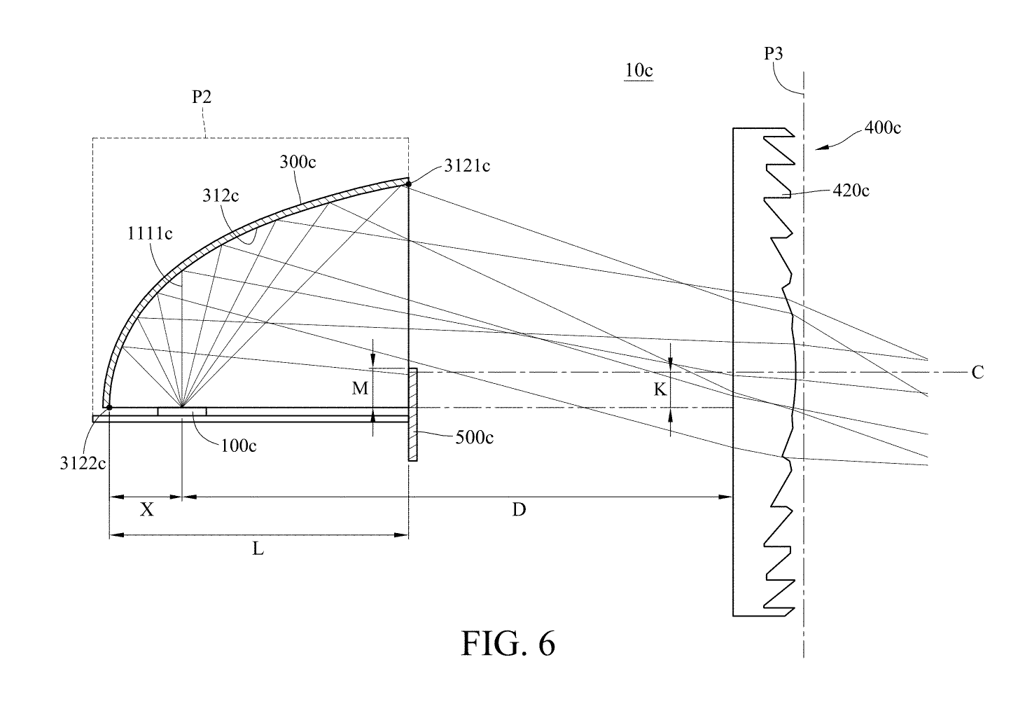

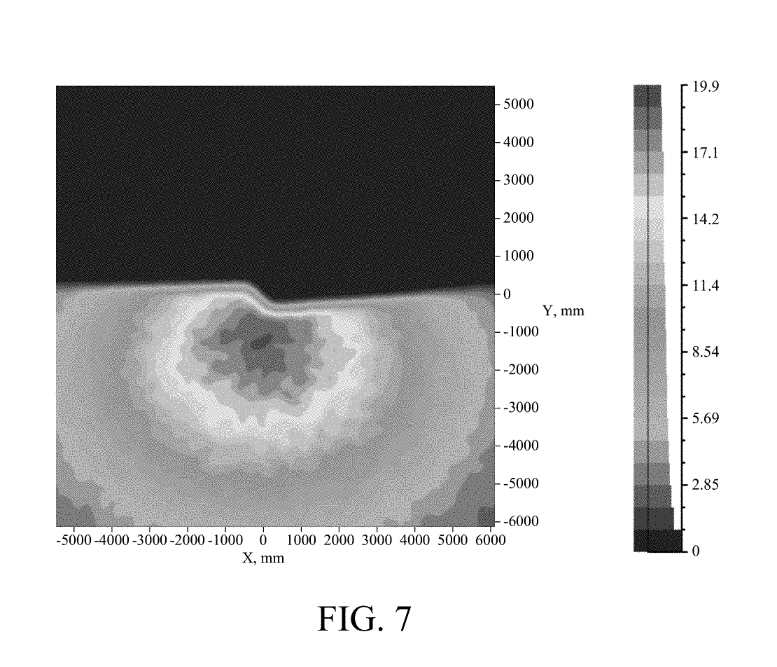

The light source, the Fresnel lens and the curved line of the reflector in the aforementioned embodiments are not restricted. Please refer to FIG. 6 and FIG. 7. FIG. 6 is a cross-sectional view of a headlight device according to a third embodiment of the disclosure. FIG. 7 is a contour diagram of illuminance produced by the headlight device in FIG. 6.

In a headlight device 10c of this embodiment, the X-coordinate and the Y-coordinate of a connecting end 3122c of a curved line 312c of a reflector 300c on a reference plane P2 are respectively 0 and 0, the X-coordinate and the Y-coordinate of an opening end 3121c of the curved line 312c are respectively 33.395 and 25.008, and the X-coordinate and the Y-coordinate of a reference point of the curved line 312c are respectively 1.820 and 18.691. A distance X between the connecting end 3122c of the curved line 312c and a light source 100c is 8.395 mm, a horizontal distance L between the connecting 3122c of the curved line 312c and the opening end 3121c is 33.395 mm. A distance D between the light source 100c and a Fresnel lens 400c is 68.5 mm. In addition, a vertical distance K between a central axis C of the Fresnel lens 400c and the connecting end 3122c is 4 mm, and a vertical distance M between the highest point of a blocking plate 500c and the connecting end 3122c is 4.5 mm, wherein the highest point and the lowest point on an upper edge of the blocking plate 500c have a vertical distance of 1 mm therebetween.

As shown in FIG. 6, according to the aforementioned arrangement, an optical axial light ray 1111c, after being reflected by the reflector 300c, would then enter into an upper part 420c of the Fresnel lens 400c, such that a vertical plane P3, where an energy convergence area is located, is located on a side of the Fresnel lens 400c away from the light source 100c.

According the aforementioned arrangement, it can be seen that a clear cut-off line on a wall at 25m away is produced by the headlight device 10c, and the greater illuminance area is concentrated on central area of the wall, such that a light pattern produced by the headlight device 10c meets the requirement of the regulation.

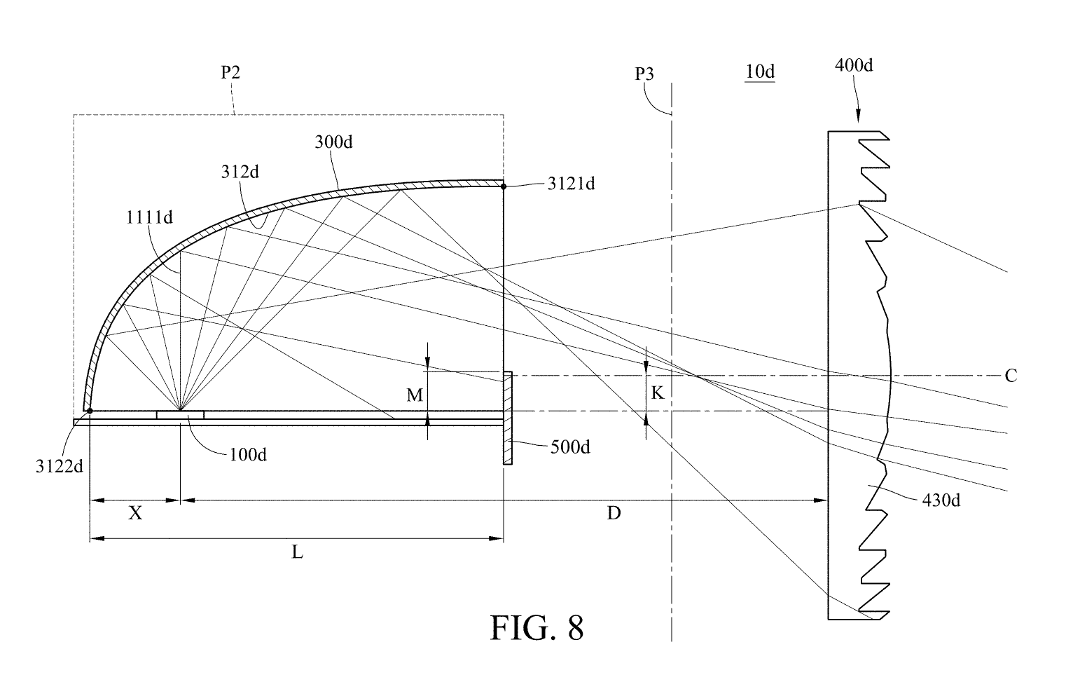

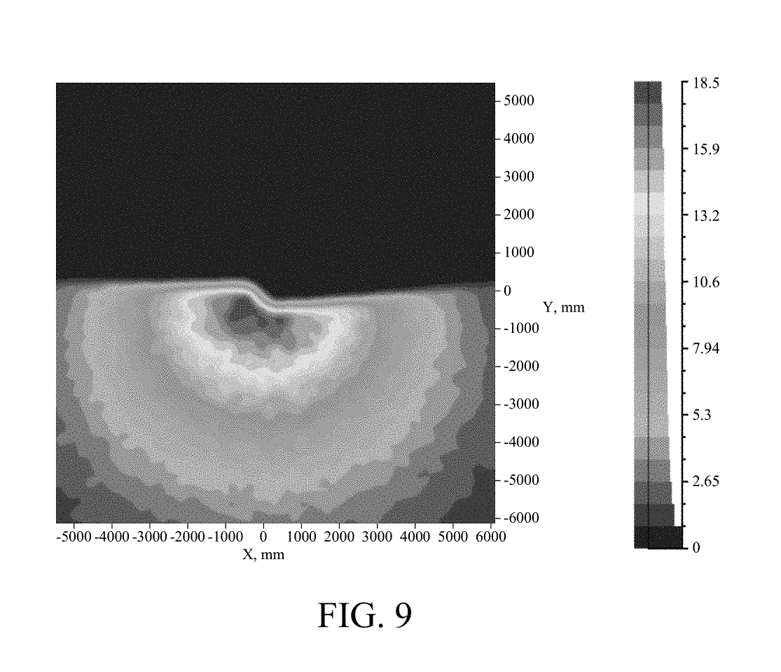

The energy convergence areas produced by the headlight devices of the aforementioned embodiments are located on the side of the Fresnel lens away from the light source, but the present disclosure is not limited thereto. Please refer to FIG. 8 and FIG. 9. FIG. 8 is a cross-sectional view of a headlight device according to a fourth embodiment of the disclosure. FIG. 9 is a contour diagram of illuminance produced by the headlight device in FIG. 8.

In a headlight device 10d of this embodiment, the X-coordinate and the Y-coordinate of a connecting end 3122d of a curved line 312d of a reflector 300d on a reference plane P2 are respectively 0 and 0, the X-coordinate and the Y-coordinate of an opening end 3121d of the curved line 312d are respectively 43.063 and 25.050, and the X-coordinate and the Y-coordinate of a reference point of the curved line 312d are respectively 4.553 and 25.185. A distance X between the connecting end 3122d of the curved line 312d and a light source 100d is 10.063 mm, and a horizontal distance L between the connecting end 3122d of the curved line 312d and the opening end 3121d is 43.063 mm. A distance D between the light source 100d and a Fresnel lens 400d is 76.5 mm. In addition, a vertical distance K between a central axis C of the Fresnel lens 400d and the connecting end 3122d is 4 mm, and a vertical distance M between the highest point of a blocking plate 500d and the connecting end 3122d is 4.5 mm, wherein the highest point and the lowest point on an upper edge of the blocking plate 500d have a vertical distance of 1 mm therebetween.

As shown in FIG. 8, according to the aforementioned arrangement, an optical axial light ray 1111d, after being reflected by the reflector 300d, then enters into a lower part 430d of the Fresnel lens 400d, such that a vertical plane P3, where an energy convergence area is located, is located between the Fresnel lens 400d and the light source 100d.

According to the aforementioned arrangement, it can be seen that a clear cut-off line on a wall at 25m away is produced by the headlight device 10d, and the greater illuminance area is concentrated on central area of the wall in FIG. 9, such that a light pattern produced by the aforementioned headlight device 10d meets the requirement of the regulation.

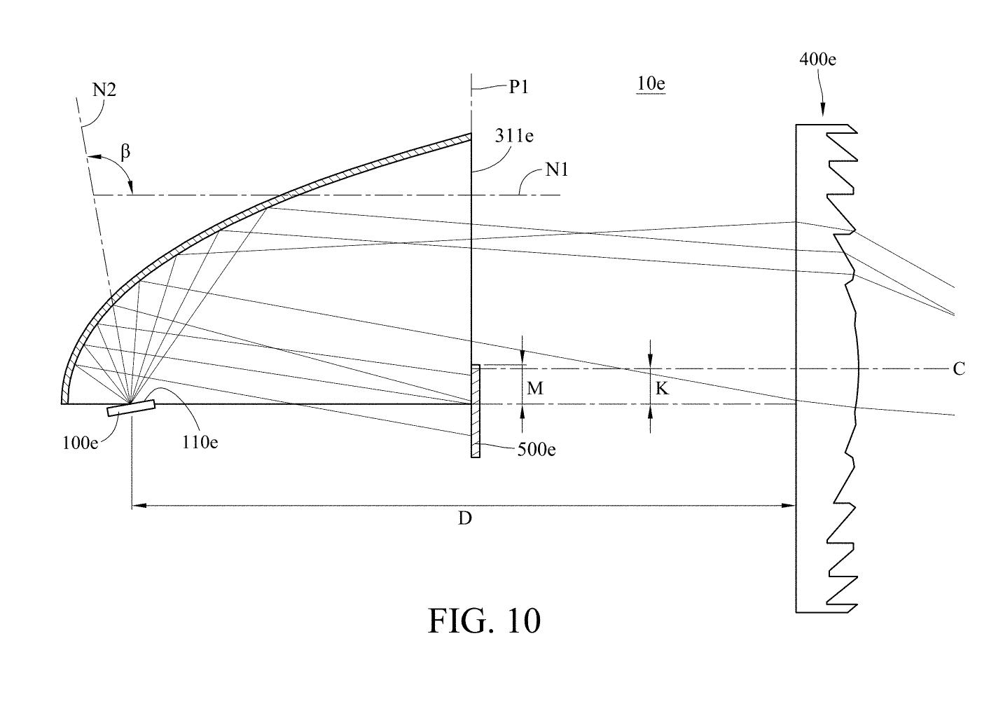

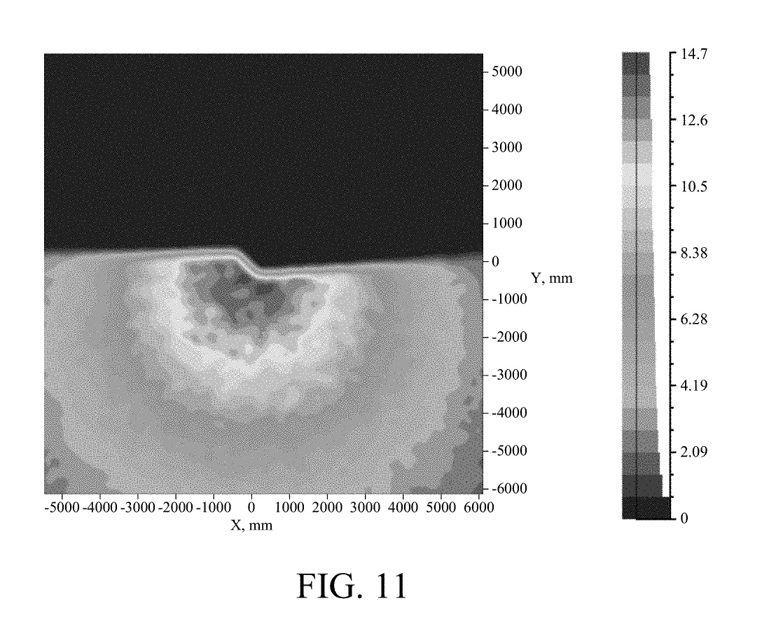

In the headlight devices of the aforementioned embodiments, the angle β between the normal line N2 of the light emitting surface of the light source and the normal line N1 of the plane P1, where the opening is located, is 90 degrees, but the angle β is not restricted. Please refer to FIG. 10 and FIG. 11. FIG. 10 is a cross-sectional view of a headlight device according to a fifth embodiment of the disclosure. FIG. 11 is a contour diagram of illuminance produced by the headlight device in FIG. 10.

In this embodiment, a headlight device 10e is similar to the headlight device 10a in FIG. 2. A normal N1 of a plane P1, where an opening 311e is located, and a normal line N2 of a light emitting surface 110e of a light source 100e have an angle β of 100 degrees, and a distance between a blocking plate 500e and a Fresnel lens 400e of the headlight device 10e is increased to 43.5 mm, such that a distance D between the light source 100e and the Fresnel lens 400e is 81.5 mm. A vertical distance K between a central axis C of the Fresnel lens 400d and a connecting end 3122e is 4 mm, and a vertical distance M between the highest point of a blocking plate 500e and the connecting end 3122e is 4.5 mm, wherein the highest point and the lowest point on an upper edge the blocking plate 500e have a vertical distance of 1 mm therebetween.

According to the aforementioned arrangement, it can be seen that a clear cut-off line is produced on a wall at 25m away by the headlight device 10e, and the greater illuminance area is concentrated on central area of the wall, such that a light pattern produced by the aforementioned headlight device 10e meets the requirement of the regulation.

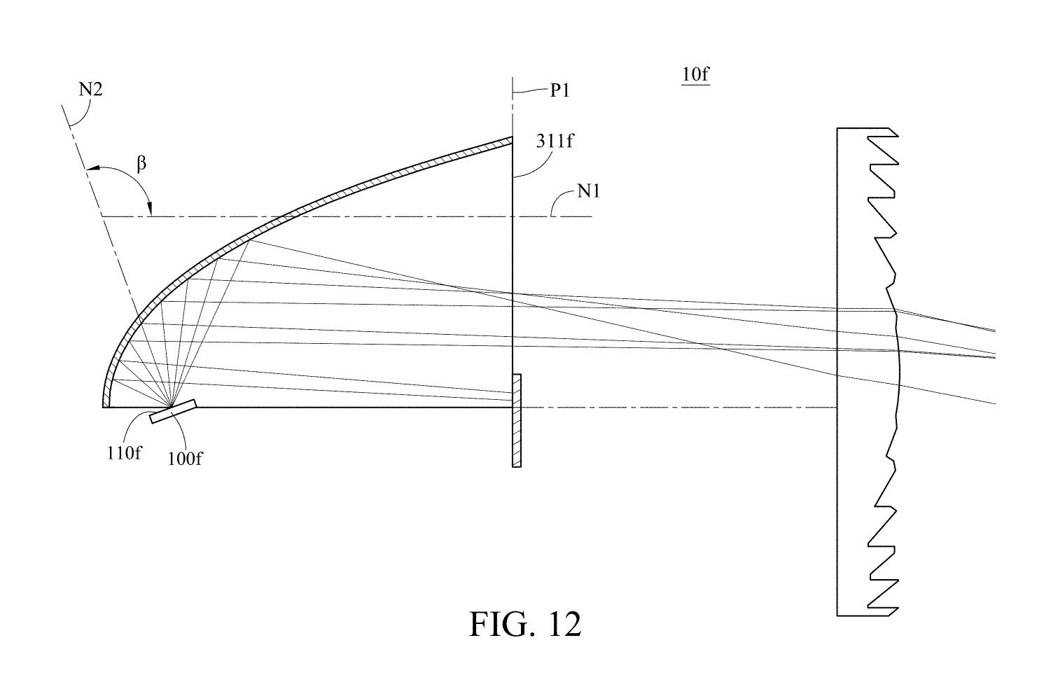

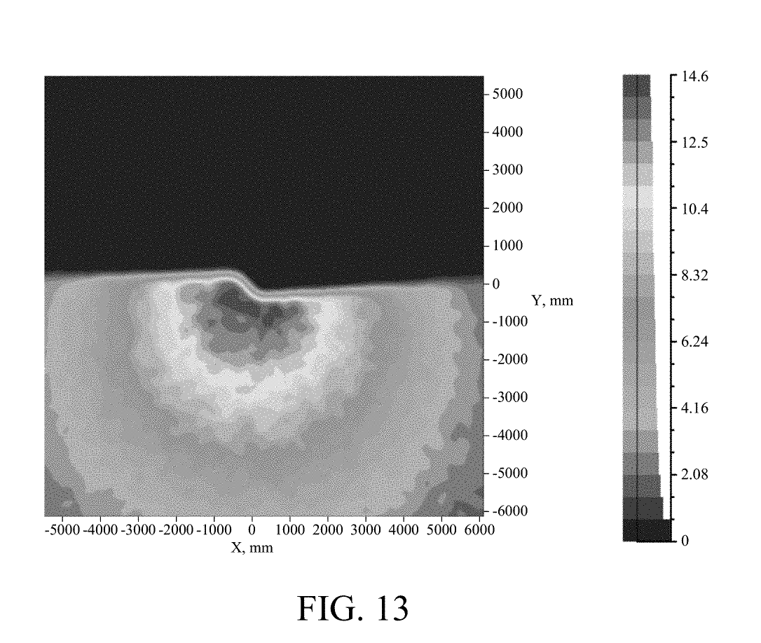

Then, please refer to FIG. 12 and FIG. 13. FIG. 12 is a cross-sectional view of a headlight device according to a sixth embodiment of the disclosure. FIG. 13 is a contour diagram of illuminance produced by the headlight device in FIG. 12.

In this embodiment, a headlight device 10f is similar to the headlight device 10e of FIG. 10. It is noted that that an angle θ between a normal line N1 of a plane P1, where an opening 311f is located, and a normal line N2 of a light emitting surface 110f of a light source 100f is 110 degrees.

According to the aforementioned arrangement, it can be seen that a clear cut-off line is produced on a wall at 25m away by the headlight device 10f, and the greater illuminance area is concentrated on central area of the wall, such that a light pattern produced by the aforementioned headlight device 10f meets the requirement of the regulation.

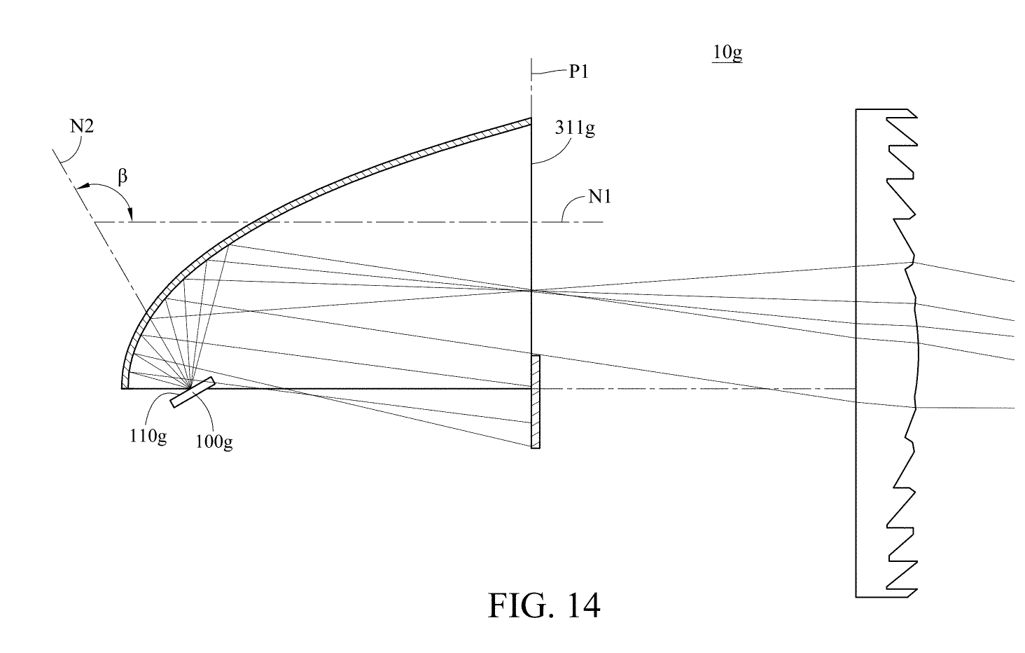

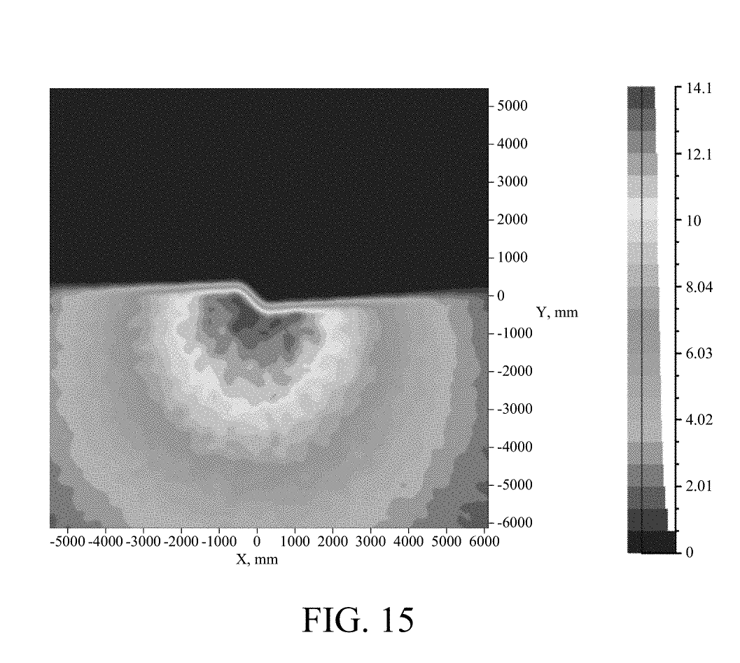

Then, please refer to FIG. 14 and FIG. 15. FIG. 14 is a cross-sectional view of a headlight device according to a seventh embodiment of the disclosure. FIG. 15 is a contour diagram of illuminance produced by the headlight device in FIG. 14.

In this embodiment, a headlight device 10g is similar to the headlight device 10e of FIG. 10. It is noted that an angle θ between a normal line N1 of a plane P1, where an opening 311g is located, and a normal line N2 of a light emitting surface 110g of a light source 100g is 120 degrees.

According to the aforementioned arrangement, it can be seen that a clear cut-off line is produced on a wall at 25m away by the headlight device 10g, and the greater illuminance area is concentrated on central area of the wall, such that a light pattern produced by the aforementioned headlight device 10g meets the requirement of the regulation.

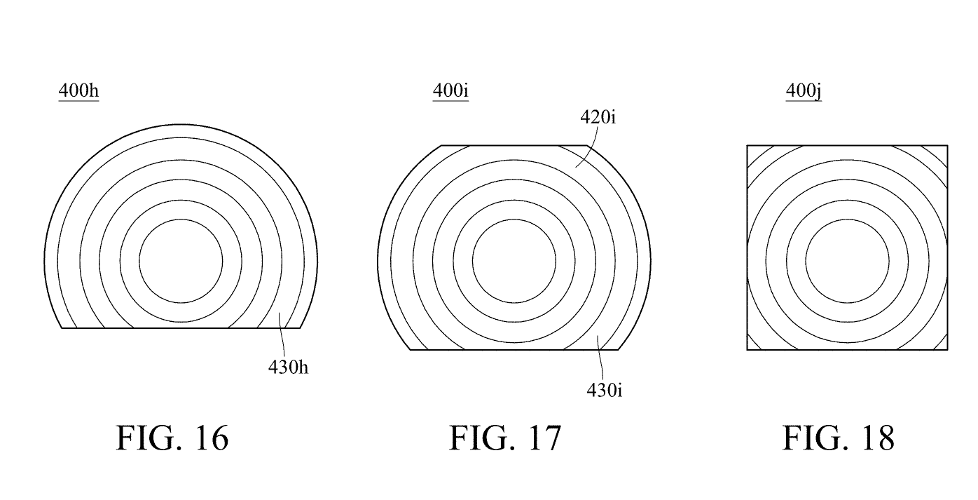

The Fresnel lenses in the aforementioned embodiments are all symmetric lenses, but the present disclosure is not limited thereto. Please refer to FIG. 16 to FIG. 18. FIG. 16 is a front view of a Fresnel lens of a headlight device according to an eighth embodiment of the disclosure. As shown in FIG. 16, in a Fresnel lens 400h of this embodiment, part of a lower part 430h is cut off so that the Fresnel lens 400h is asymmetric, and this decrease the volume of the headlight device having the Fresnel lens 400h down to 84.32% of the original volume. FIG. 17 is a front view of a Fresnel lens of a headlight device according to a ninth embodiment of the disclosure. As shown in FIG. 17, in a Fresnel lens 400i of this embodiment, part of a lower part 430i and part of an upper part 420i are cut off, but the parts being cut off are different, such that the Fresnel lens 400i is asymmetric, thereby decreasing the volume of the headlight device having the Fresnel lens 400i down to 79.97% of the original volume. FIG. 18 is a front view of a Fresnel lens of a headlight device according to a tenth embodiment of the disclosure. As shown in FIG. 18, in a Fresnel lens 400j of this embodiment, the Fresnel lens 400j is cut from different sides so as to from a lens that is asymmetric at the upside and the downside but symmetric at the left side and the right side, such that the volume of the headlight device having the Fresnel lens 400j is decreased to 57.55% of the original volume, but the present disclosure is not limited thereto. In some other embodiments, a Fresnel lens may be a lens that is asymmetric at all sides.

According to the headlight device as discussed above, because the reflecting surface of the reflector, which is defined by the quadratic Bezier curved function, with the help of the blocking plate, the light pattern produced by the light beam, emitted by the light source and then passing through the Fresnel lens, not only meets the requirement of the regulation, but also can decrease the volume and the weight of the headlight device, thereby increasing the turning sensitivity of the headlight device cooperated with the adaptive front lighting system.

In addition, the position of the light source can be adjusted so as to make the light ray, after being reflected by the reflector, enter into the upper part or lower part of the Fresnel lens, so the part of the Fresnel lens which is not passed by the light ray is able to be cut off, thereby further decreasing the volume and the weight of the Fresnel lens. As such, the much lighter Fresnel lens is able to decrease the volume and weight of the overall headlight device, such that the turning sensitivity of the headlight device cooperated with the adaptive front lighting system is able to be increased.

It will be apparent to those skilled in the art that various modifications and variations can be made to the present disclosure. It is intended that the specification and examples be considered as exemplary embodiments only, with a scope of the disclosure being indicated by the following claims and their equivalents.

### SYMBOL DESCRIPTION

10a, 10b, 10c, 10d, 10e, 10f and 10g: headlight device
100a, 100b, 100c, 100d, 100e, 100f and 100g: light source
110a, 110e, 110f and 110g: light emitting surface
111a: light beam
1111a, 1111b, 1111c and 1111d: optical axial light ray
1112a: edge light ray
200a: circuit board
300a, 300b, 300c and 300d: reflector
310a: reflecting surface
311a, 311e, 311f and 311g: opening
312a, 312b, 312c and 312d: curved line
3121a, 3121b, 3121c and 3121d: opening end
3122a, 3122b, 3122c, 3122d and 3122e: connecting end
400a, 400c, 400d, 400e, 400h, 400i and 400j: Fresnel lens
400b: lens
410a: central part
420a, 420c and 420i: upper part
430a, 430d, 430h and 430i: lower part
500a, 500c, 500d and 500e: blocking plate
α: divergence angle
β: angle
C: central axis
N1 and N2: normal line
P1: plane
P2: reference plane
P3: vertical plane
I: optical axis
K: distance
M: vertical distance between the highest point of blocking plate and connecting end
θ1: incident angle
θ2: reflected angle
P₀ₓ: X-coordinate of connecting end
P_{0y}: Y-coordinate of connecting end
P₂ₓ: X-coordinate of opening end
P_{2y}: Y-coordinate of opening end
P₁ₓ: X-coordinate of reference point of curved line
P_{1y}: Y-coordinate of reference point of curved line
t: coefficient in determining any point on the curved line
Bₓ₍ₜ₎: X-coordinate of any point on curved line
B_{y(t)}: Y-coordinate of any point on curved line
tₓ: a coefficient in determining a point on curved line which is corresponding to light source
Φ: angle between optical axial light ray of light beam on optical axis of light source, reflected by reflecting surface, and direction of opening
L: horizontal distance between opening end and connecting end
X: distance between light source and connecting end
D: distance between light source and Fresnel lens
H: vertical distance between opening end and connecting end

1. A headlight device, comprising:
a light source disposed on a circuit board, and the light source has a light emitting surface;
a reflector disposed on a side of the circuit board and covering the light source, the reflector has a reflecting surface, the reflecting surface facing the light emitting surface, an opening formed by a side of the reflecting surface, and an angle between a direction of the opening and the normal line of the light emitting surface equal to or greater than 90 degrees;
a Fresnel lens located on a side of the opening opposite to the light source; and
a blocking plate;
wherein a light beam emitted from the light emitting surface is reflected by the reflecting surface and then passes through the Fresnel lens, the light beam converges towards an energy convergence area on a vertical plane, the blocking plate is located between the vertical plane and the light source in order to block part of the light beam so as to create a light pattern having a cut-off line;
wherein a reference plane is defined to perpendicular to the opening, an optical axis of the light source is on the reference plane, the reflecting surface and the reference plane intersect at a curved line on the reflecting surface, and the curved lined line has an opening end and a connecting end opposite to each other, the connecting end is located on a side of the reflector close to the circuit board, the curved line is defined by a quadratic Bezier curved function, and the quadratic Bezier curved function comprises:
Bₓ(t)=(1−t)²P₀ₓ+2t(1−t)P₁ₓ+t²P₂ₓ, t∈[0,1]; and
B_{y}(t)=(1−t)²P_{0y}+2t(1−t)P_{1y}+t²P_{2y}, t∈[0,1];
wherein the connecting end is an origin of a coordinate, the X-coordinate and the Y-coordinate of the connecting end are respectively P₀ₓ and P_{0y}, the X-coordinate and the Y-coordinate of the opening end are respectively P₂ₓ and P_{2y}, the X-coordinate and the Y-coordinate of a reference point in adjusting the curvature of the curved line are respectively P₁ₓ and P_{1y}, the coefficient in determining any point on the curved line is t, and the X-coordinate and the Y-coordinate of any point on the curved line are respectively Bₓ(t) and B_{y}(t).

2. The headlight device according to claim 1, wherein the light beam has a divergence angle ranging between 90 degrees and 120 degrees.

3. The headlight device according to claim 1, wherein a direction of the opening and the normal line of the light emitting surface have an angle equal to 90 degrees.

4. The headlight device according to claim 3, wherein a coefficient in determining a point on the curved line which is corresponding to the light source is tₓ, an optical axial light ray of the light beam on the optical axis of the light source, which is reflected by the reflecting surface, and the direction of the opening have an angle of Φ, a horizontal distance between the opening end and the connecting end is L, a distance between the light source and the connecting end is X, and the following condition is satisfied:
B_{y}(tₓ)/tan(Φ)≥L−X.

5. The headlight device according to claim 4, wherein a distance between the light source and the Fresnel lens is D, the Fresnel lens includes an upper part and a lower part, the upper part is closer to the opening end of the curved line than the lower part, and the following condition is satisfied when the light beam reflected by the reflecting surface passes through the lower part:

|B_{y}(tₓ)/tan(Φ)|≤D.

6. The headlight device according to claim 4, wherein a distance between the light source and the Fresnel lens is D, the Fresnel lens includes an upper part and a lower part, the upper part is closer to the opening end of the curved line than the lower part, and the following condition is satisfied when the light beam reflected by the reflecting surface passing through the upper part:

|B_{y}(tₓ)/tan(Φ)|≥D.

7. The headlight device according to claim 3, wherein a coefficient in determining a point on the curved line which is corresponding to the light source is tₓ, an optical axial light ray of the light beam on the optical axis of the light source, which is reflected by the reflecting surface, has an incident angle and a reflected angle, and the X-coordinate of the light source meets the following condition when the incident angle and the reflected angle are both smaller than 45 degrees:
Bₓ(tₓ)=(1−tₓ)²P₀ₓ+2tₓ(1−tₓ)P₁ₓ+tₓ²P₂ₓ, tₓ∈(0.35,1].

8. The headlight device according to claim 3, wherein a horizontal distance between the opening end and the connecting end is L, a vertical distance between the opening end and the connecting end is H, a distance between the light source and the connecting end is X, and the following condition is satisfied:
L−H≥X.

9. The headlight device according to claim 1, wherein an optical axial light ray of the light beam on the optical axis of the light source which is reflected by the reflecting surface, has an incident angle and a reflected angle, and the incident angle and the reflected angle are both smaller than 45 degrees.

10. The headlight device according to claim 1, wherein an optical axial light ray of the light beam on the optical axis of the light source, which is reflected by the reflecting surface, and the direction of the opening have an angle, and the minimum value of the angle is −28.78 degrees.

11. The headlight device according to claim 1, wherein a luminous intensity direction passing through the Fresnel lens and the direction of the opening have an angle ranging between 0 dgree and −2 degrees.

12. The headlight device according to claim 1, wherein the Fresnel lens is a symmetric lens or an asymmetric lens.
